(19) United States
(12) Patent Application Publication
(10) Pub. No.: US 2020/0236255 A1
(43) Pub. Date: Jul. 23, 2020

(54) IMAGING APPARATUS AND SHADING CORRECTION METHOD

(71) Applicant: SONY CORPORATION, TOKYO (JP)

(72) Inventors: TOYOKAZU TAKAHASHI, TOKYO (JP); SHINTAROU MORITA, KANAGAWA (JP)

(21) Appl. No.: 15/755,627

(22) PCT Filed: Jun. 3, 2016
(86) PCT No.: PCT/JP2016/066671

§ 371 Date: Feb. 27, 2018

(30) Foreign Application Priority Data
Sep. 10, 2015 (JP) 2015-178510

(51) Int. Cl. H04N 5/225; H04N 5/357; H04N 5/238

(52) U.S. Cl. CPC H04N 5/2254; H04N 5/238; H04N 5/357

(57) ABSTRACT

A liquid crystal light control device is to be used appropriately, regardless of interchanges of lenses. To achieve this, an imaging apparatus includes: a mount portion on which an interchangeable lens is mounted; a liquid crystal light control device that performs light control on incident light entering via a lens system in the interchangeable lens when the interchangeable lens is mounted on the mount portion; and an imaging device that generates a captured image signal by photoelectrically converting the incident light via the liquid crystal light control device. The mount portion, the liquid crystal light control device, and the imaging device are arranged in this order from the object side in the optical axis direction of the incident light. The liquid crystal light control device can be made to function, regardless of the types of lenses to be interchanged.

### TECHNICAL FIELD

The present technology relates to a technical field of an imaging apparatus that includes a liquid crystal light control device.

### CITATION LIST

### Patent Documents

### Patent Document 1: Japanese Patent Application Laid-Open No. 2002-82358

### Patent Document 2: Japanese Patent Application Laid-Open No. 2000-196953

### BACKGROUND ART

An imaging apparatus that is widely used as a digital still camera, a video camera, or the like includes a lens and an imaging device provided on the optical axis of the lens. A light control device is provided between the lens and the imaging device. With this light control device, the amount of light traveling from the lens toward the imaging device is adjusted.

Liquid crystal light control devices are known as such light control devices. In an imaging apparatus that includes a liquid crystal light control device, the ND density can be steplessly varied, and automatic light control can be performed under various conditions.

Patent Document 1 discloses configurations and operations related to a liquid crystal light control device and an imaging apparatus.

Patent Document 2 discloses a technique for correcting shading at different levels depending on lenses in a camera system.

### SUMMARY OF THE INVENTION

### Problems to be Solved by the Invention

Meanwhile, any known example does not use a liquid crystal light control device in a lens-interchangeable imaging apparatus system.

Therefore, the present disclosure suggests a more effective design of a light control device in a lens-interchangeable imaging apparatus.

### Solutions to Problems

An imaging apparatus according to the present technology includes: a mount portion on which an interchangeable lens is mounted; a liquid crystal light control device that performs light control on incident light entering via a lens system in the interchangeable lens when the interchangeable lens is mounted on the mount portion; and an imaging device that generates a captured image signal by photoelectrically converting the incident light via the liquid crystal light control device. The mount portion, the liquid crystal light control device, and the imaging device are arranged in this order from the object side in the optical axis direction of the incident light.

That is, the light control device is disposed in the main body of the imaging apparatus to which the interchangeable lens is attached.

The above imaging apparatus according to the present technology may further include a signal processing unit that performs a first correction process on the captured image signal output from the imaging device, to correct shading caused by the liquid crystal light control device.

That is, correction is performed on the captured image signal, so that shading caused due to the employment of the liquid crystal light control device does not occur in the captured image.

In the above imaging apparatus according to the present technology, the signal processing unit may perform a second correction process on the captured image signal output from the imaging device, to correct shading caused by the lens system.

With this, shading caused by the lens system can also be corrected.

The above imaging apparatus according to the present technology may further include a control unit that sets a correction value for the first correction process, in accordance with an exit pupil distance and a transmittance of the liquid crystal light control device.

In a device that uses liquid crystal, shading occurs in a captured image due to an interaction between incident light and liquid crystal molecules. The shading caused by this liquid crystal light control device changes with the exit pupil distance and the transmittance. Therefore, a correction value is determined in accordance with the exit pupil distance and the transmittance.

The above imaging apparatus according to the present technology may further include a communication unit that performs communication with the interchangeable lens mounted on the mount portion. The control unit may acquire information about the exit pupil distance from the interchangeable lens through the communication performed by the communication unit.

As the information about the exit pupil distance is acquired from the interchangeable lens through communication, the information about the exit pupil distance corresponding to the attached lens can be acquired even after lenses are interchanged.

In the above imaging apparatus according to the present technology, the control unit may cause the communication unit to perform communication with the interchangeable lens at predetermined time intervals, to acquire the information about the exit pupil distance.

As communication is performed at predetermined time intervals, exit pupil distance information can be successively obtained.

In the above imaging apparatus according to the present technology, the control unit may variably control the transmittance of the liquid crystal light control device.

If the control unit is designed to variably control the transmittance of the liquid crystal light control device, the control unit can recognize the current transmittance of the liquid crystal light control device from the controlled value of the transmittance, without acquiring transmittance information from outside.

In the above imaging apparatus according to the present technology, a communication terminal is preferably provided on the mount portion, and the communication terminal is preferably brought into contact with a communication terminal of the interchangeable lens when the interchangeable lens is mounted on the mount portion, to form a communication path between the communication unit and the interchangeable lens mounted on the mount portion.

As communication with the interchangeable lens is performed in a contact state, stable communication can be successively performed, and shading correction can also be appropriately performed.

In the above imaging apparatus according to the present technology, the liquid crystal light control device may be retracted from the incident light path.

As the liquid crystal light control device is retracted, the transmittance can be maximized.

Also, in the above imaging apparatus according to the present technology, a clear glass may be inserted into the incident light path while the liquid crystal light control device is in a retracted state.

As the clear glass is inserted into the incident light path, it is possible to achieve a state similar to the optical state in a case where the liquid crystal light control device is in the incident light path.

Further, the liquid crystal light control device in a retracted state is located in a position that overlaps amount ring in the mount portion when viewed from the optical axis direction of the incident light. With this, the external shape is prevented from becoming larger.

Further, when the liquid crystal light control device is inserted into the incident light path, the clear glass is retracted from the incident light path, and is located in a position that overlaps the mount ring in the mount portion when viewed from the optical axis direction of the incident light. With this, the external shape is also prevented from becoming larger.

A shading correction method according to the present technology is a shading correction method in an imaging apparatus that includes the above described mount portion, the liquid crystal light control device, the imaging device, and the signal processing unit. The shading correction method includes setting a correction value for the correction process, in accordance with exit pupil distance information and the transmittance of the liquid crystal light control device.

Thus, correction is performed with an appropriate correction value so that shading due to the liquid crystal light control device does not occur in the captured image.

### Effects of the Invention

According to the present technology, a liquid crystal light control device is provided on the imaging apparatus side in a lens-interchangeable imaging apparatus. Therefore, there is no need to provide a light control device on the side of various interchangeable lenses. Thus, automatic control can be suitably performed on the liquid crystal light control device in the main body of the imaging apparatus.

It should be noted that the effects of the present technology are not necessarily limited to the effects described herein, and may include any of the effects described in the present disclosure.

### BRIEF DESCRIPTION OF DRAWINGS

FIG. 1 is a diagram for explaining an imaging apparatus according to an embodiment of the present technology.

FIG. 2 is a front view of the imaging apparatus according to the embodiment, without any interchangeable lens.

FIG. 3 is a cross-sectional diagram showing the layout in the liquid crystal light control device of the imaging apparatus according to the embodiment.

FIG. 4 is a block diagram of the internal configuration of the imaging apparatus according to the embodiment.

FIG. 5 is a diagram for explaining the liquid crystal light control device according to the embodiment.

FIG. 6 is a diagram for explaining transmittance calculation in the liquid crystal light control device according to the embodiment.

FIG. 7 is a diagram for explaining amounts of shading to be performed by the liquid crystal light control device.

FIG. 8 is a diagram for explaining shading to be performed by the liquid crystal light control device.

FIG. 9 is a diagram for explaining correction tables according to the embodiment.

FIG. 10 is a diagram for explaining a functional configuration for shading correction according to the embodiment.

FIG. 11 is a flowchart showing processing to be performed by a control unit according to the embodiment.

FIG. 12 is a diagram for explaining timings for operations to be performed by the control unit according to the embodiment.

### MODE FOR CARRYING OUT THE INVENTION

Embodiments will be described below in the following order.

<1. Structure of an Imaging Apparatus>

<2. Internal Configuration>

<3. Shading Correction>

<4. Summary and Modifications>

### 1. Structure of an Imaging Apparatus

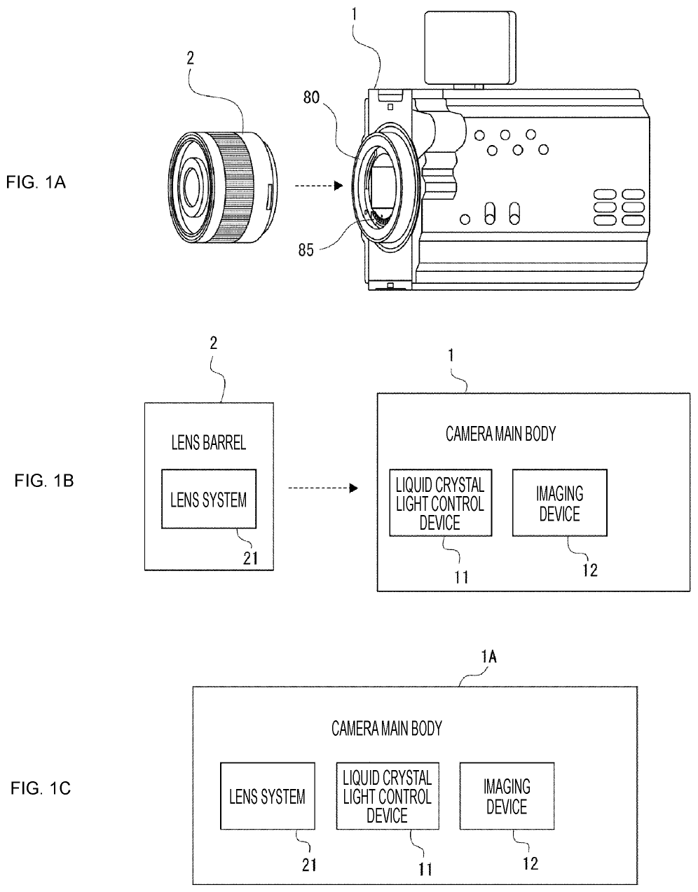

FIGS. 1A and 1B schematically show the structure of an imaging apparatus according to an embodiment.

FIG. 1A shows an imaging apparatus 1 and a lens barrel 2 as one of interchangeable lenses that can be mounted on the imaging apparatus 1. The external shapes of the imaging apparatus 1 and the lens barrel 2 shown in the drawing are merely an example. This embodiment is basically a lens-interchangeable video camera or digital still camera.

FIG. 1B schematically shows a liquid crystal light control device 11 and an imaging device 12 that are disposed in the camera main body of the imaging apparatus 1.

A lens system 21 formed with optical components such as a plurality of lenses including a zoom lens and a focus lens is provided on the side of the lens barrel 2. In this embodiment, when the lens barrel 2 is attached to the imaging apparatus 1, the intensity of incident light via the lens system 21 is controlled by the liquid crystal light control device 11 on the side of the imaging apparatus 1, and is received by the imaging device 12.

It should be noted that FIG. 1C shows the case of a lens-integrated imaging apparatus 1A that is not of a lens-interchangeable type, and the lens system 21 is of course also disposed inside the main body of the imaging apparatus 1 in this case. Even in the case of such an integrated camera, the liquid crystal light control device 11 is useful, which will be described later in an explanation of a modification.

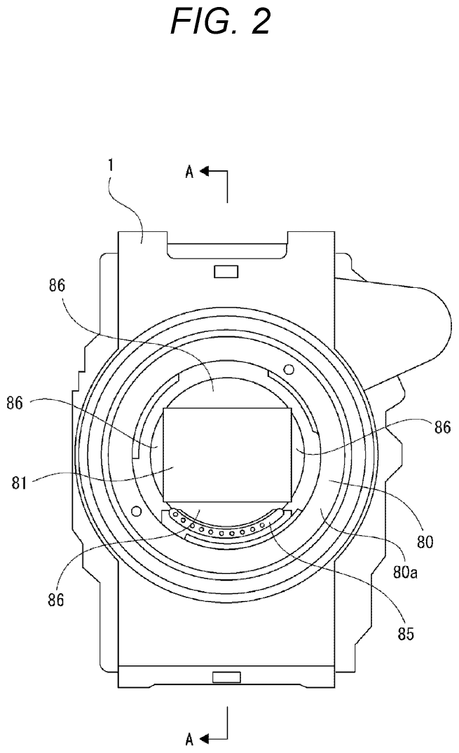

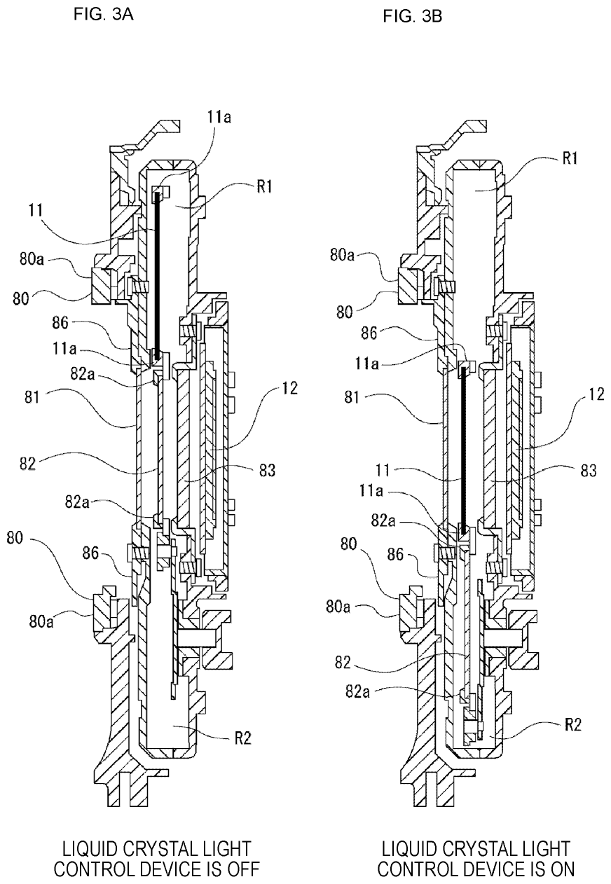

FIG. 2 is a front view of the imaging apparatus 1. FIGS. 3A and 3B each show the optical components including the imaging device 12 as part of a cross-section taken along the line A-A defined in FIG. 2.

FIG. 2 is a front view of the imaging apparatus 1 without the lens barrel 2 attached thereto. Therefore, a mount portion 80 to which the lens barrel 2 is to be attached is exposed on the front side.

A terminal portion 85 is provided on the inner circumferential side along the mount ring 80a that forms the mount portion 80. The terminal portion 85 is formed with a plurality of electrical contacts, and functions as a communication terminal for communicating with the lens barrel 2 to which the imaging apparatus 1 is connected. The lens barrel 2 corresponding to the imaging apparatus 1 is provided with electrical contacts to be brought into contact with the respective electrical contacts of the terminal portion 85 in an attached state, and the communication path between the imaging apparatus 1 and the lens barrel 2 is formed by the contact state.

On the inner circumferential side of the mount ring 80a, a cover glass 81 is disposed as an opening portion for capturing incident light. It should be noted that this is merely an example, and there may be a structure that does not include the cover glass 81.

The peripheries of the cover glass 81 serve as mold portions 86 for blocking incident light. The structure shown in FIGS. 3A and 3B is disposed in the optical axis direction from the cover glass 81.

FIG. 3A shows an example state in which the liquid crystal light control device 11 is retracted from the incident light path. FIG. 3B shows an example state in which the liquid crystal light control device 11 is disposed in the incident light path.

For example, the liquid crystal light control device 11 is normally disposed as shown in FIG. 3B, so that the liquid crystal light control device 11 executes its light control function. In a case where the amount of incident light is to be increased, on the other hand, the liquid crystal light control device 11 is retracted as shown in FIG. 3A, so that almost 100% of incident light can pass through the portion.

In the state shown in FIG. 3B, the cover glass 81, the liquid crystal light control device 11, an optical low-pass filter 83, and the imaging device 12 are arranged in this order in the traveling direction of incident light (the optical axis direction). It should be noted that the order of arrangement of the liquid crystal light control device 11 and the optical low-pass filter 83 may be reversed.

In the state shown in FIG. 3A, the cover glass 81, a clear glass 82, the optical low-pass filter 83, and the imaging device 12 are arranged in this order in the traveling direction of incident light.

It should be noted that the order of arrangement of the clear glass 82 and the optical low-pass filter 83 may be reversed.

In this example, the liquid crystal light control device 11 is retracted into a space R1 in the state shown in FIG. 3A, and the clear glass 82 is retracted into a space R2 in the state shown in FIG. 3B.

When the liquid crystal light control device 11 is retracted as shown in FIG. 3A, the liquid crystal light control device 11 moves to such a position as not to overlap the position of the cover glass 81 in the optical axis direction, and, after the movement, the liquid crystal light control device 11 is located in such a position as to overlap at least the position of the mount ring 80a in the optical axis direction. In this state, the position of the liquid crystal light control device 11 further overlaps the positions of the mold portions 86 in the optical axis direction.

As the liquid crystal light control device 11 in a retracted state is located in a position that overlaps the mount ring 80a and the mold portions 86 when viewed from the optical axis direction (viewed from the object side) as described above, the space R1 can be made smaller. That is, if the liquid crystal light control device 11 is retracted upward in the drawing, it becomes necessary to widen the space R1 in a direction perpendicular to the optical axis. However, as the position for retraction is set as shown in the drawing, the space R1 can be minimized.

Also, in the state shown FIG. 3B, the position of the clear glass 82 overlaps the position of the mount ring 80a in the optical axis direction. Further, in that state, the position of the mount ring 80a also overlaps with the positions of the mold portions 86 in the optical axis direction.

As the position of the clear glass 82 in a retracted state is made to overlap the positions of the mount ring 80a and the mold portions 86 when viewed from the optical axis direction (or viewed from the object side) as described above, the space R2 can be made smaller. That is, if the clear glass 82 is retracted downward in the drawing, it becomes necessary to widen the space R2 in a direction perpendicular to the optical axis. However, as the position of retraction is set as shown in the drawing, the space R2 can be minimized.

In this example, the clear glass 82 is disposed in the incident light path when the liquid crystal light control device 11 is retracted from the incident light path. This is to maintain a state that is similar to the optical state in which the liquid crystal light control device 11 is located in the incident light path, even when the liquid crystal light control device 11 is retreated from the incident light path. Therefore, the clear glass 82 has a function of matching the optical lengths to each other by taking into account the refractive indexes of the materials.

Meanwhile, the liquid crystal light control device 11 is held by a holder 11a, and the clear glass 82 is held by a holder 82a. Furthermore, the holders 11a and 82a connected to each other are moved up and down, so that the liquid crystal light control device 11 is inserted/retreated.

With this mechanism, the liquid crystal light control device 11 and the clear glass 82 can be collectively moved. Thus, the mechanism for retracting the liquid crystal light control device 11 and recovering the liquid crystal light control device 11 from retraction is simplified, and the operation to switch between the liquid crystal light control device 11 and the clear glass 82 in the incident light path is stabilized.

It should be noted that the retracting direction (the position of retraction) of the clear glass 82 may be 180 degrees the opposite of the retracting direction (the position of retraction) of the liquid crystal light control device 11 across the imaging device 12, or the clear glass 82 may be retracted in a direction at 90 degrees to the retracting direction of the liquid crystal light control device 11. Further, the retracting direction (the position of retraction) of the clear glass 82 may be the same as the retracting direction (the position of retraction) of the liquid crystal light control device 11.

### 2. Internal Configuration

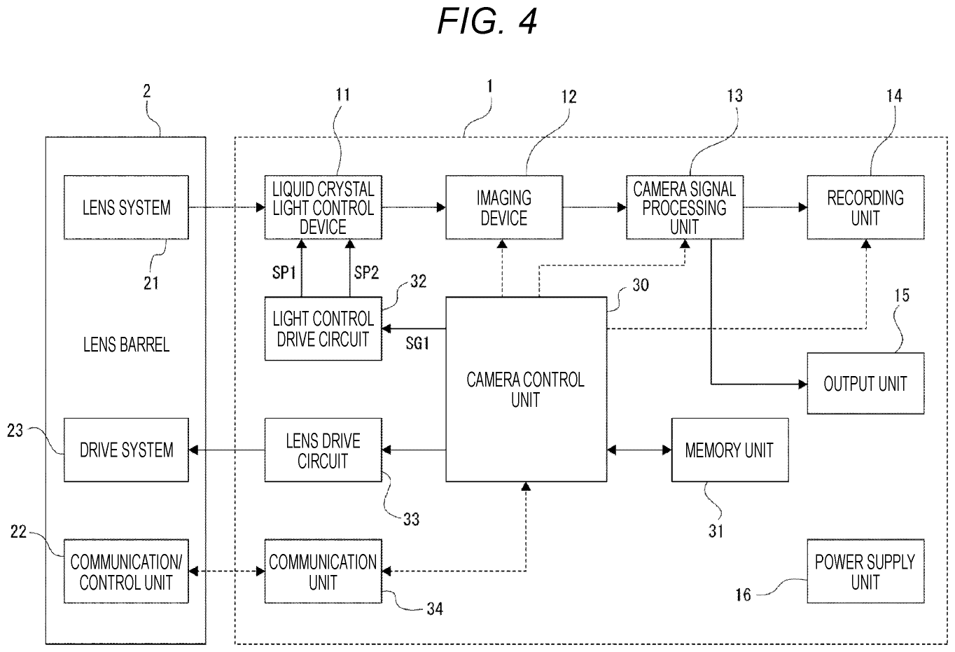

FIG. 4 shows the internal configuration of the imaging apparatus 1 according to the embodiment. FIG. 4 also shows the lens barrel 2 attached to the imaging apparatus 1.

The imaging apparatus 1 includes the liquid crystal light control device 11, the imaging device (an imager) 12, a camera signal processing unit 13, a recording unit 14, an output unit 15, a power supply unit 16, a camera control unit 30, a memory unit 31, a light control drive circuit 32, a lens drive circuit 33, and a communication unit 34.

Furthermore, although not shown in the drawing, components for user interfaces such as a display unit and an operation unit are normally also included.

The lens system 21 in the lens barrel 2 includes lenses such as a cover lens, a zoom lens, a focus lens, and a diaphragm mechanism. By this lens system 21, light (incident light) from the object is guided and gathered onto the imaging device 12 via the liquid crystal light control device 11 in the imaging apparatus 1.

The liquid crystal light control device 11 adjusts the amount of incident light. The structure of the liquid crystal light control device 11 will be described later.

The imaging device 12 is of a charge coupled device (CCD) type or a complementary metal oxide semiconductor (CMOS) type, for example.

In the imaging device 12, a correlated double sampling (CDS) process, an automatic gain control (AGC) process, or the like is performed on an electric signal obtained by photoelectrically converting received light, and an analog/digital (A/D) conversion process is further performed on the electric signal. An imaging signal as digital data is then output to the camera signal processing unit 13 in the subsequent stage.

The camera signal processing unit 13 is formed as an image processor, such as a digital signal processor (DSP). The camera signal processing unit 13 performs various kinds of signal processing on a digital signal (a captured image signal) from the imaging device 12. For example, the camera signal processing unit 13 performs preprocessing, a synchronization process, a YC generation process, a resolution conversion process, a codec process, and the like.

In the preprocessing, a clamp process for clamping the black level of R, G, and B to a predetermined level, a correction process between the color channels of R, G, and B, and the like are performed on the captured image signal from the imaging device 12.

In the synchronization process, a demosaicing process is performed so that the image data of each pixel has R, G, and B color components.

In the YC generation process, a luminance (Y) signal and a color (C) signal are generated (separated) from the R, G, and B image data.

In the resolution conversion process, resolution conversion is performed on the image data subjected to the various kinds of signal processing.

In the codec process, a coding process for recording or communication, for example, is performed on the image data subjected to the resolution conversion.

Particularly, in this embodiment, the camera signal processing unit 13 in the preprocessing stage, for example, also performs a correction process to correct shading caused due to imaging of incident light via the liquid crystal light control device 11, and a correction process to correct shading caused by the lens system 21.

The recording unit 14 is formed with a nonvolatile memory, for example, and stores image files (content files) of still image data, moving image data, and the like, attribute information about the image files, thumbnail images, and the like.

The image files are stored in a format such as Joint Photographic Experts Group (JPEG), Tagged Image File Format (TIFF), Graphics Interchange Format (GIF), or the like.

The recording unit 14 can take various forms in practice. For example, the recording unit 14 may be a flash memory included in the imaging apparatus 1, or may be formed with a memory card (for example, a portable flash memory) that can be detachably attached to the imaging apparatus 1 and a card recording/reproducing unit that makes recording/reproducing access to the memory card. Alternatively, as a component to be included in the imaging apparatus 1, the recording unit 14 may be formed as a hard disk drive (HDD) or the like.

The output unit 15 performs data communication or network communication with an external device in a wired or wireless manner.

The output unit 15 transmits or outputs captured image data (a still image file or a moving image file) to an external display device, an external recording device, an external reproducing device, or the like.

Alternatively, if the output unit 15 is a network communication unit, the output unit 15 may perform communication via various networks such as the Internet, a home network, a local area network (LAN), and transmit and receive various kinds of data to and from servers, terminals, and the like in the networks.

The power supply unit 16 generates the power supply voltage necessary for the respective components, using a power supply that is the voltage of a built-in battery or a DC voltage converted and input by an AC adapter connected to a commercial AC power supply, for example. The power supply unit 16 then supplies the power supply voltage as an operating voltage.

The camera control unit 30 is formed with a microcomputer (an arithmetic processing unit) that includes a central processing unit (CPU).

The memory unit 31 stores information and the like to be used for processing by the camera control unit 30. For example, the memory unit 31 is a read only memory (ROM), a random access memory (RAM), a flash memory, and the like. The memory unit 31 may be a memory area included in a microcomputer chip serving as the camera control unit 30, or may be formed with a separate memory chip.

The camera control unit 30 controls the entire imaging apparatus 1 by executing a program stored in the ROM, the flash memory, or the like of the memory unit 31.

For example, the camera control unit 30 controls necessary operations of the respective components, such as the shutter speed of the imaging device 12, instructions as to various kinds of signal processing in the camera signal processing unit 13, imaging operations and recording operations according to user operations, recorded image file reproducing operations, camera operations such as zooming, focusing, and exposure adjustment, and user interface operations.

The RAM in the memory unit 31 is used as a work area for various kinds of data processing by the CPU, to temporarily store data, programs, and the like.

The ROM and the flash memory (nonvolatile memory) in the memory unit 31 are used to store an operating system (OS) for the CPU to control each component, content files such as image files, application programs for various kinds of operations, firmware, and the like.

In this example, a correction table for shading correction, which will be described later, is also stored in the flash memory, for example.

The light control drive circuit 32 changes transmittance by driving the liquid crystal light control device with liquid crystal drive signals SP1 and SP2. The light control drive circuit 32 sets amplitude levels of the liquid crystal drive signals SP1 and SP2 in accordance with a luminance instruction (a light control signal SG1) from the camera control unit 30, for example, and outputs the amplitude levels to the liquid crystal light control device 11.

It should be noted that two liquid crystal drive signals are shown as the liquid crystal drive signals SP1 and SP2, because the liquid crystal light control device 11 has a two-layer structure as will be described later as an example of the embodiment, and drives each liquid crystal layer.

The lens drive circuit 33 outputs a drive signal for a drive system 23 of the lens barrel 2 in accordance with an instruction from the camera control unit 30.

The drive unit 23 of the lens barrel 2 includes, for example, a motor for driving the focusing lens and the zoom lens in the lens system 21, a motor for driving the diaphragm mechanism, and the like. The lens drive circuit 33 outputs drive signals for these motors, and causes the lens barrel 2 to perform necessary operations.

The communication unit 34 performs communication with the lens barrel 2.

The lens barrel 2 is equipped with a communication/control unit 22 formed with a microcomputer, for example, and the camera control unit 30 can perform various kinds data communication with the communication/control unit 22 via the communication unit 34. In this embodiment, the camera control unit 30 obtains information about the exit pupil distance of the lens system 21 in the lens barrel 2 through communication performed by the communication unit 34.

It should be noted that communication between the communication unit 34 and the communication/control unit 22, and supplies of motor drive signals from the lens drive circuit 33 to the drive system 23 are performed through cable connections via the terminal portion 85 shown in FIG. 2 (and the terminal portion (not shown) on the side of the lens barrel 2).

The liquid crystal light control device 11 mounted on this imaging apparatus 1 is now described.

The liquid crystal light control device 11 is a light control device that uses guest-host (GH) liquid crystal cells.

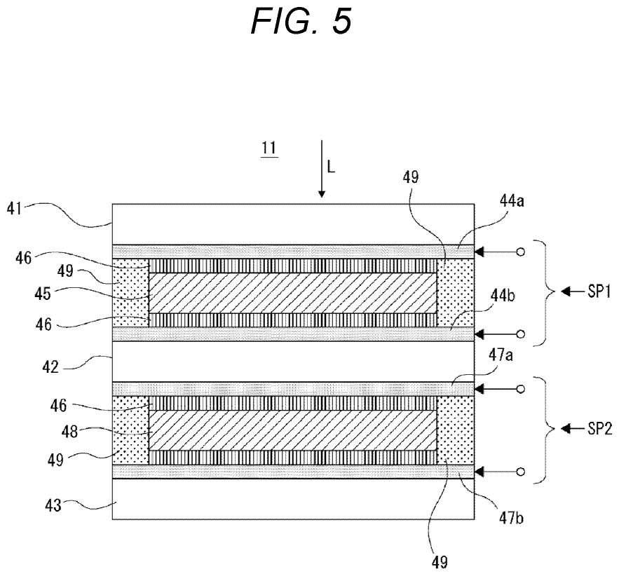

FIG. 5 shows the structure of the liquid crystal light control device 11.

The liquid crystal light control device 11 is provided with glass substrates 41, 42, and 43, and has two liquid crystal layers 45 and 48 in the traveling direction (an arrow L) of the light to be controlled.

First, the glass substrates 41 and 42 are arranged, with a sealing material 49 being interposed in between, as shown in the drawing. The liquid crystal layer 45 is then formed between the glass substrates 41 and 42. Transparent electrode films 44a and 44b are provided on the respective liquid crystal layer sides of the glass substrates 41 and 42. Light distribution films 46 and 46 are also provided on both sides of the liquid crystal layer 45.

The glass substrates 42 and 43 are also arranged, with a sealing material 49 being interposed in between, as shown in the drawing. The other liquid crystal layer 48 is formed between the glass substrates 42 and 43. Transparent electrode films 47a and 47b are provided on the respective liquid crystal layer sides of the glass substrates 42 and 43. Light distribution films 46 and 46 are also provided on both sides of the liquid crystal layer 48.

The sealing material 49 seals the liquid crystal layers 45 and 48 from the side surface sides, for example. The sealing material 49 is an adhesive such as an epoxy adhesive or an acrylic adhesive.

Furthermore, although FIG. 5 shows the structure in a cross-sectional direction, the liquid crystal light control device 11 further has a sealing portion and a spacer that are not shown in the drawing.

The spacer may be disposed to maintain a constant cell gap between the liquid crystal layers 45 and 48. For example, a resin material or a glass material is used.

The sealing portion is an enclosing port for enclosing liquid crystal, and the liquid crystal is enclosed from outside.

In the liquid crystal light control device 11, the alignment films 46 are formed with a polymer material such as polyimide, and are subjected to a rubbing treatment beforehand in a predetermined direction, so that the orientation direction of the liquid crystal molecules is set.

The liquid crystal layers 45 and 48 contain predetermined dye molecules (dichroic dye molecules) as well as guest-host (GH) liquid crystal molecules. The GH liquid crystal is of a negative type or a positive type, depending on differences in the long axis direction of the liquid crystal molecules at the time of voltage application. For example, in positive-type GH liquid crystal, the long axis direction of the liquid crystal molecules is perpendicular to the optical axis when no voltage is applied (off-state), while the long axis direction of the liquid crystal molecules is parallel to the optical axis when a voltage is applied (on-state).

The two liquid crystal layers 45 and 48 of the liquid crystal light control device 11 each have upper and lower electrodes (the transparent electrode films 44a and 44b, and the transparent electrode films 47a and 47b), and are driven with four signals in total. Specifically, the liquid crystal drive signal SP1 at the positive electrode level and the negative electrode level, and the liquid crystal drive signal SP2 at the positive electrode level and the negative electrode level are applied.

To maintain durability of the liquid crystal, AC inversion is essential, and two-phase clocks are supplied to the two electrodes of each of the liquid crystal layer 45 and 48. Specifically, the liquid crystal drive signal SP1 that is set as a clock pulse at a certain frequency, and an inversion signal thereof are applied to the transparent electrode films 44a and 44b. Likewise, the liquid crystal drive signal SP2 that is set as a clock pulse at a certain frequency, and an inversion signal thereof are applied to the transparent electrode films 47a and 47b.

The transmittance of the liquid crystal light control device 11 to which the liquid crystal drive signals SP1 and SP2 at a certain frequency and amplitude are supplied becomes higher as the amplitude is increased, depending on the type of the liquid crystal. Alternatively, the transmittance becomes lower as the amplitude is increased.

Specifically, the camera control unit 30 supplies the light control signal SG1 as a luminance instruction value to the light control drive circuit 32, and the light control drive circuit 32 outputs the liquid crystal drive signals SP1 and SP2 of the amplitude according to the instruction. As a result, the transmittance of the liquid crystal light control device 11 is changed, and thus, a light control operation is performed.

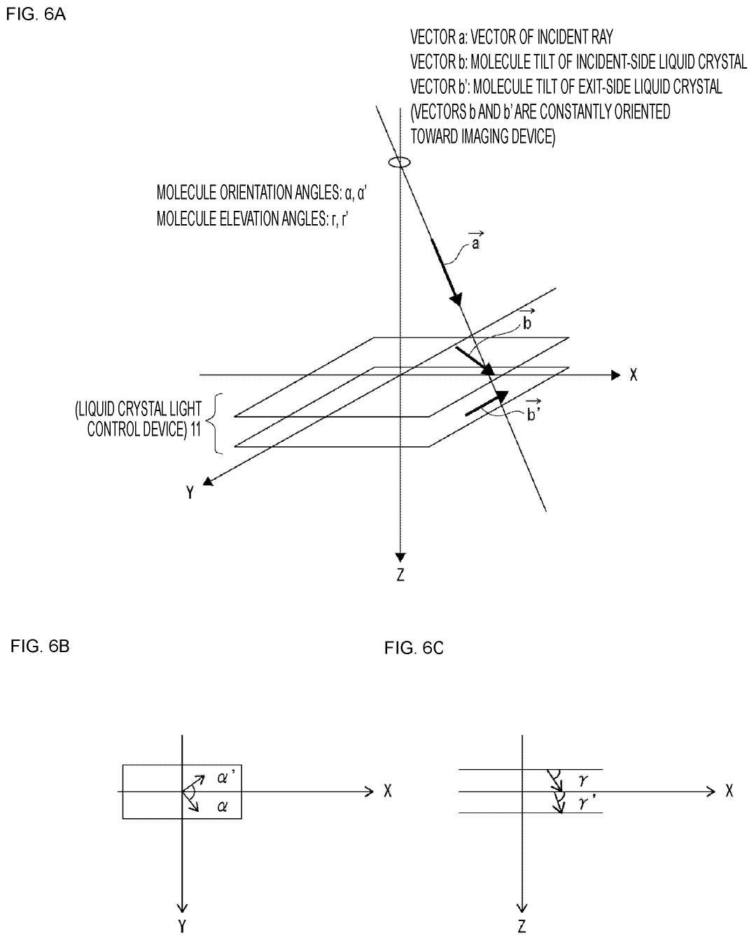

FIG. 6A shows a calculation model for the transmittance of the liquid crystal light control device 11.

The respective values are as follows.

Vector a: the ray vector of incident light

Vector b: the vector of the liquid crystal molecules (dye) of the liquid crystal layer 45 on the incident side

Vector b′: the vector of the liquid crystal molecules (dye) of the liquid crystal layer 48 on the exit side

Ii: the intensity of the light ray

t: the transmittance when γ of the liquid crystal layer 45 on the incident side is 90 degrees

t′: the transmittance when γ′ of the liquid crystal layer 48 on the exit side is 90 degrees

α: the light distribution angle of the liquid crystal molecules on the incident side

γ: the elevation angle of the liquid crystal molecules on the incident side

α′: the light distribution angle of the liquid crystal molecules on the exit side

γ′: the elevation angle of the liquid crystal molecules on the exit side

Furthermore, in FIG. 6B, α and α′ are shown in the X-Y plane. In FIG. 6C, γ and γ′ are shown in the X-Z plane.

In this case, the respective vectors are expressed as below.

$$\vec{a} = {I}_{i} ( \begin{matrix}{x}_{i} \\ {y}_{i} \\ {z}_{i}\end{matrix} ) \\ \vec{b} = t ( \begin{matrix}cos γ cos α \\ cos γ sin α \\ sin γ\end{matrix} ) \\ \vec{{b}^{′}} = {t}^{′} ( \begin{matrix}cos {γ}^{′} cos {α}^{′} \\ cos {γ }^{′} sin {α}^{′} \\ sin {γ}^{′}\end{matrix} ) \qquad [ Mathematical Expression 1 ]$$

Furthermore, since the intensity of a light ray passing through a dye is the inner product of the ray vector and the dye vector, the transmittance T of the liquid crystal light control device 11 is expressed as below.

T=\vec{a}·\vec{b}×\vec{a}·\vec{b′} [Mathematical Expression 2]

### 3. Shading Correction

As described above, the imaging apparatus 1 of this embodiment is a lens-interchangeable camera. Furthermore, the liquid crystal light control device 11 is disposed in front of the imaging device 12 in the lens optical system of the imaging apparatus 1 (the camera main body). It should be noted that the liquid crystal light control device 11 described below is in a mode in which the transmittance becomes higher as the voltage of the liquid crystal drive signals SP1 and SP2 becomes higher.

In the shading to be performed by the liquid crystal light control device 11 on a captured image, the amount of transmission to the imaging device 12 is determined by the angle between the light ray incident on the liquid crystal light control device 11 and the liquid crystal molecules varying with the voltage applied to the liquid crystal light control device 11 in the camera optical system.

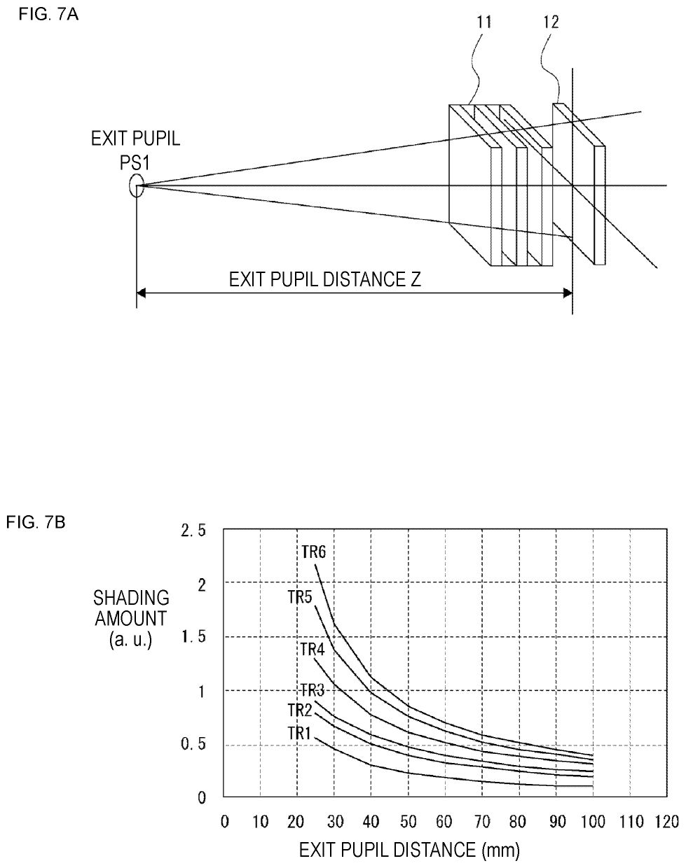

As shown in FIG. 7A, the point serving as the starting point of the light ray in this case is the position PS1 of the exit pupil (exit pupil distance Z) determined by the optical system from the lens to the imaging device 12 on the optical axis of the normal line in the plane of the liquid crystal light control device 11. The amount of light incident on each point on the imaging surface of the imaging device 12 from the position PS1 via the liquid crystal light control device 11 is calculated as the inner product of the angle of the incident light at each corresponding point and the angle of the liquid crystal molecules as described above.

The value of the light amount shading calculated by the above principles in an image on the imaging surface of the imaging device 12 actually coincides, in a preferred correlation, with shading in an image output from an optical system under the same conditions.

As for the characteristics shown in FIG. 7B, the ordinate axis indicates the amount of shading, and the abscissa axis indicates the exit pupil distance. Each curve shows a relationship between the exit pupil distance and the shading amount in a case where the transmittance of the liquid crystal light control device 11 varies from a transmittance TR1 to a transmittance TR7.

As can be seen from the graph, the shading amount has a correlation with the exit pupil distance and the transmittance.

Accordingly, it is possible to obtain shading map data to be corrected in accordance with the states of the exit pupil and the liquid crystal light control device 11.

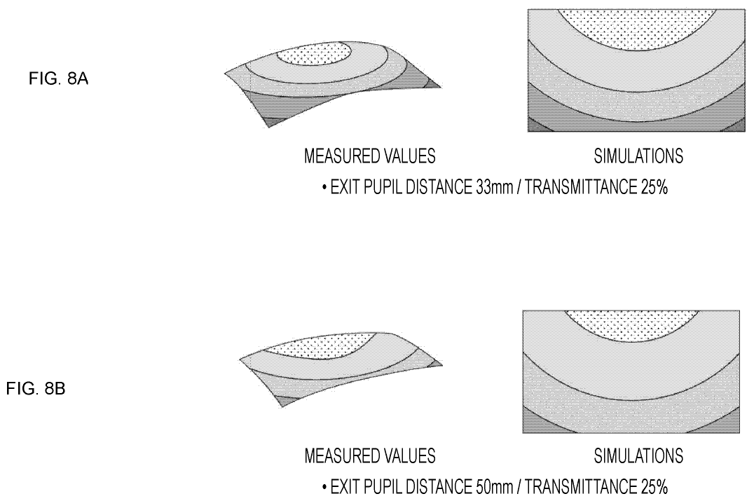

FIG. 8A shows contour lines that indicate measured values of shading amounts and simulation results in a case where the exit pupil distance Z is 33 mm and the transmittance is 25%.

Meanwhile, FIG. 8B shows measured values of shading amounts and simulation results in a case where the exit pupil distance Z is 50 mm and the transmittance is 25%.

As the shading amount in a captured image can be determined from the combination of the exit pupil distance Z and the transmittance in this manner, for example, it should be understood that a correction coefficient table for shading correction can be generated for each combination of the exit pupil distance Z and the transmittance TR.

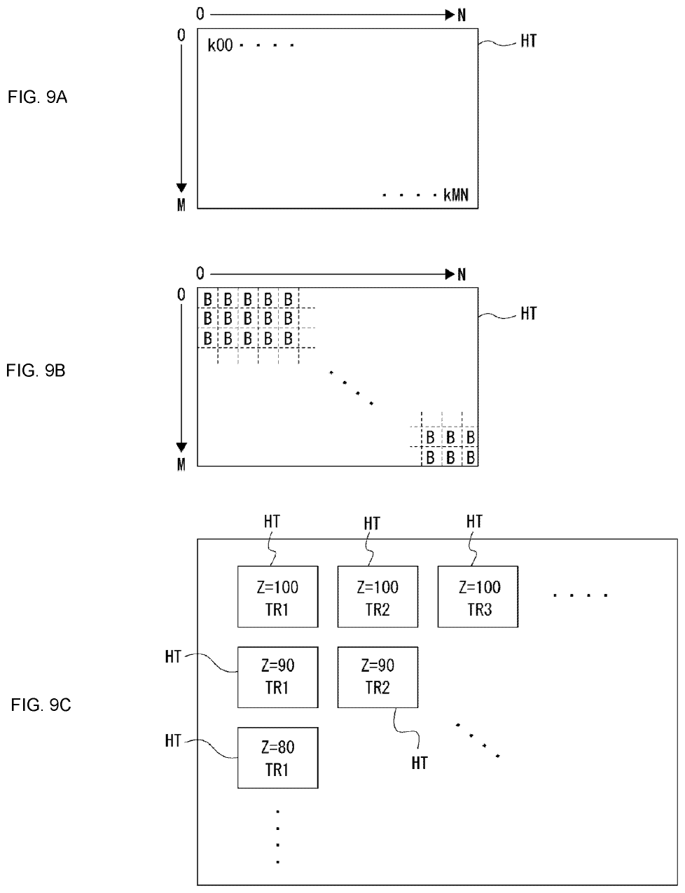

Referring now to FIG. 9, examples of correction coefficient tables are described.

FIG. 9A shows a correction coefficient table HT. Where the number of pixels in one field of a captured image signal is (M×N), the table in this example contains M×N correction coefficients (k00 to kMN) corresponding to the respective pixels. The correction coefficients k corresponding to the respective pixels are determined in accordance with the shading amounts shown in FIG. 8.

FIG. 9B shows an example of the correction coefficient table HT in which the pixels in one screen are divided into blocks, and correction coefficients are set for the respective blocks B. That is, this is an example where the same correction coefficient value is set for each of the pixels in one block B.

Since a shading amount is determined in accordance with the position of the pixel as shown in FIG. 8, the correction accuracy does not drop by a large amount, even if a certain number of pixels are divided into blocks. In view of this, a correction coefficient k may be set for each block B, as shown in FIG. 9B. This enables reduction of the storage capacity required for the table and reduction of the processing load. The size (the number of pixels) of each block B may be varied.

For example, a correction coefficient table HT like the one shown in FIG. 9A or 9B is prepared for each combination of an exit pupil distance Z and a transmittance.

For example, as shown in FIG. 9C, a correction coefficient table HT is prepared for each of the transmittances TR1, TR2, TR3, . . . in relation to an exit pupil distance Z of 100 mm.

Further, in cases where exit pupil distances Z are 90 mm, 80 mm, . . . , a correction coefficient table HT is prepared for each transmittance.

It should be noted that preparing correction coefficient tables HT for all the combinations of exit pupil distances Z and transmittances TR is not realistic. For example, where exit pupil distances Z are 100 mm, 99 mm, 98 mm, . . . , and transmittances TR are 100%, 99%, 98%, . . . , the number of correction coefficient tables HT becomes enormous if correction coefficient tables HT are prepared for all the combinations.

Therefore, as shown in FIG. 9C, an exit pupil distance and a transmittance are combined at each predetermined point, and correction coefficient tables HT are prepared for these combinations, for example. In a situation to which the above is not applicable, a correction coefficient may be generated through an interpolation process.

For example, in the case of the transmittance TR1 and the exit pupil distance Z of 95 mm, a correction coefficient table HT (Z=100 mm/TR1) and a correction coefficient table HT (Z=90 mm/TR1) are used, and each correction coefficient k is generated through an interpolation process using the correction coefficient values stored in the two correction coefficient tables HT.

Although each correction coefficient table HT is a table storing correction coefficients k for the respective pixels or respective blocks B in the above example, each correction coefficient table HT may be stored as an arithmetic expression for obtaining correction coefficients k through a predetermined calculation process. That is, information in any form may be used, as long as the correction coefficients k corresponding to the respective pixels can be obtained in accordance with the relationship between the exit pupil distance and the transmittance.

A shading correction operation according to this embodiment is now described.

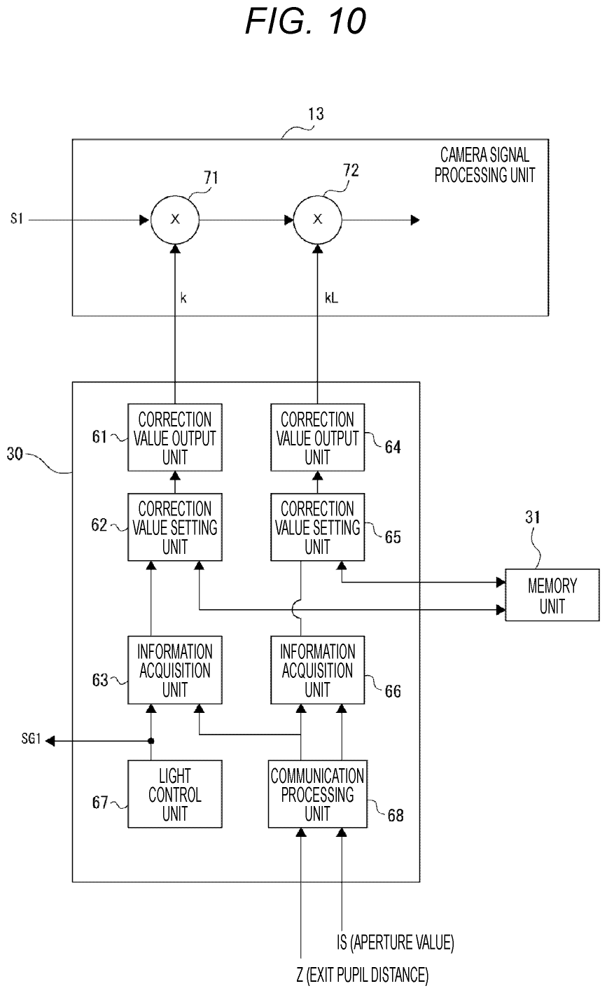

FIG. 10 shows the configuration for shading correction in the camera signal processing unit 13, and the functional configuration for shading correction in the camera control unit 30.

The camera signal processing unit 13 includes a coefficient multiplier 71 for correcting shading caused by the liquid crystal light control device 11 for a captured image signal S1, and a coefficient multiplier 72 for correcting shading caused by the lens system 21 on the side of the lens barrel 2.

The coefficient multipliers 71 and 72 multiply each pixel value of the captured image signal S1 by correction coefficients k and kL.

It should be noted that the correction coefficients k are correction coefficients that are for the respective pixels and are supplied to the camera signal processing unit 13 in accordance with the correction coefficient tables HT prepared for shading correction related to the liquid crystal light control device 11 as shown in FIG. 9.

Although not described below in detail, the correction coefficients kL are correction coefficients that are for the respective pixels and are supplied to the camera signal processing unit 13 in accordance with the correction coefficient tables prepared for shading correction related to the lens system 21.

The coefficient multipliers 71 and 72 are formed as one multiplication procedure in a signal processing operation in the DSP serving as the camera signal processing unit 13, for example, but the coefficient multipliers 71 and 72 may be formed with multipliers as hardware.

The camera control unit 30 includes a correction value output unit 61, a correction value setting unit 62, and an information acquisition unit 63 as the functions for shading correction related to the liquid crystal light control device 11, and these functions are designed as arithmetic operation procedures to be carried out by software, for example.

The camera control unit 30 also includes a correction value output unit 64, a correction value setting unit 65, and an information acquisition unit 66 as the functions for shading correction related to the lens system 21, and these functions are designed as arithmetic operation procedures to be carried out by software, for example.

The camera control unit 30 further includes a communication processing unit 68 that controls communication with the lens barrel 2 via the communication unit 34, and the communication processing unit 68 is designed as a function to be executed by software, for example.

The camera control unit 30 also includes a light control unit 67 that outputs the light control signal SG1 instructing the light control drive circuit 32 about the brightness level, and the light control unit 67 is designed as a function to be executed by software, for example.

In the memory unit 31, tables as the above described correction coefficient tables HT are stored. It should be noted that, in this example, tables for shading correction related to the lens system 21, and tables for shading correction related to the liquid crystal light control device 11 are stored.

As a function for shading correction related to the liquid crystal light control device 11, the information acquisition unit 63 acquires information about the transmittance TR and information about the exit pupil distance Z.

The transmittance of the liquid crystal light control device 11 is set by the camera control unit 30 using the light control signal SG1 through the function of the light control unit 67. Thus, the information acquisition unit 63 can recognize the current transmittance TR of the liquid crystal light control device 11 by successively checking the light control signal SG1.

The information acquisition unit 63 also acquires the information about the exit pupil distance Z from the communication processing unit 68. As the communication processing unit 68 causes the communication unit 34 to successively perform communication, the information about the current exit pupil distance Z can be acquired from the lens barrel 2.

The correction value setting unit 62 performs a process of setting correction values, in accordance with the information about the exit pupil distance Z and the transmittance TR acquired by the information acquisition unit 63.

For example, the correction coefficient table HT corresponding to the combination of the exit pupil distance Z and the transmittance TR is identified from among the correction coefficient tables HT stored in the memory unit 31, and the correction coefficients k for the respective pixels in the correction coefficient table HT are acquired. Alternatively, an interpolation process using the correction coefficients k in a plurality of correction coefficient tables HT as described above is performed, and the correction coefficients k for the respective pixels are generated in accordance with the current exit pupil distance Z and the current transmittance TR.

The correction value output unit 61 sequentially supplies the correction coefficients set by the correction value setting unit 62, such as the correction coefficients k for the respective pixels in one field, to the camera signal processing unit 13 in synchronization with the timing of the captured image signal S1, and then causes the coefficient multiplier 71 to perform a multiplication process.

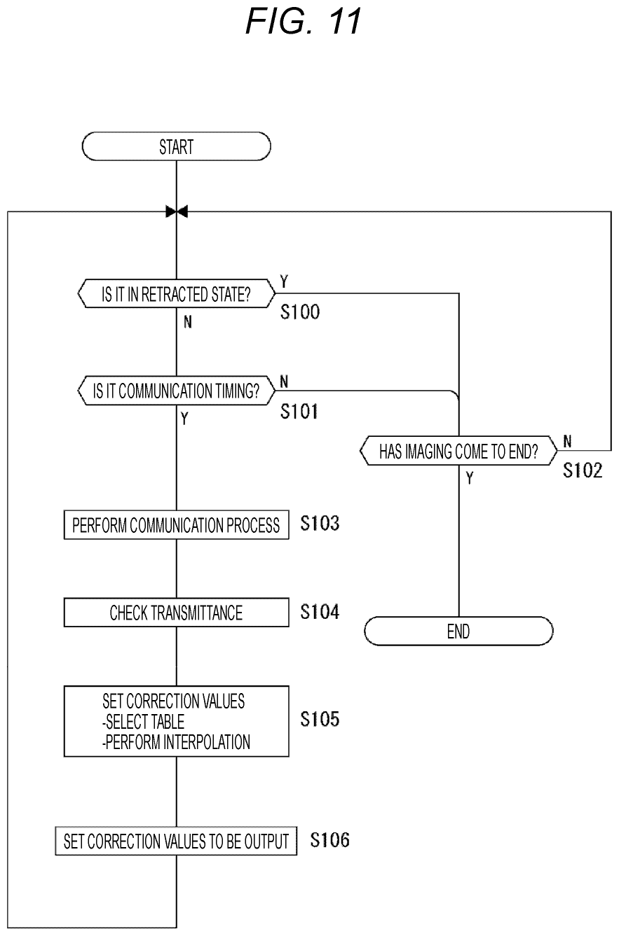

FIG. 11 shows an example process to be performed by the camera control unit 30 formed with the above functions.

The camera control unit 30 repeatedly performs the process shown in FIG. 11 while an imaging operation (a photoelectric conversion operation) is performed by the imaging device 12. That is, the process is repeated during the period from the start of an operation of the imaging device 12 till the end of the imaging (the end of the photoelectric conversion operation of the imaging apparatus 1) is determined in step S102. An operation of the imaging device 12 is normally started when the power supply to the imaging apparatus 1 is turned on in an imaging mode.

Instep S100, the camera control unit 30 determines whether the liquid crystal light control device 11 is currently in a retracted state (the state shown in FIG. 3A). If the liquid crystal light control device 11 is in a retracted state, any correction process related to the liquid crystal light control device 11 is of course not performed, and monitoring is performed in step S102.

While the liquid crystal light control device 11 is not in a retracted state, the camera control unit 30 checks the communication timing in step S101, and confirms the end of imaging in step S102.

For example, the camera control unit 30 communicates with the lens barrel 2 at regular intervals. In step S101, the regular communication timing is checked.

When determining the current time to be a communication timing, the camera control unit 30 causes the communication unit 34 to communicate with the lens barrel 2 in step S103. The camera control unit 30 then receives information about the exit pupil distance Z as a communication result.

In step S104, the camera control unit 30 recognizes the current transmittance TR of the liquid crystal light control device 11. To do so, the camera control unit 30 simply has to check the value indicated by the latest light control signal SG1.

In step S105, the camera control unit 30 sets correction values. That is, the correction coefficient table HT corresponding to the exit pupil distance Z and the transmittance TR is identified as described above, or the correction coefficients k (k00 to kMN) to be assigned to the respective pixel values of the captured image signal S1 are set by an interpolation process.

Then, in step S106, the camera control unit 30 sets the correction coefficients k as the correction coefficients to be output to the camera signal processing unit 13. The correction coefficients k (k00 to kMN) are supplied to the camera signal processing unit 13 at a predetermined timing.

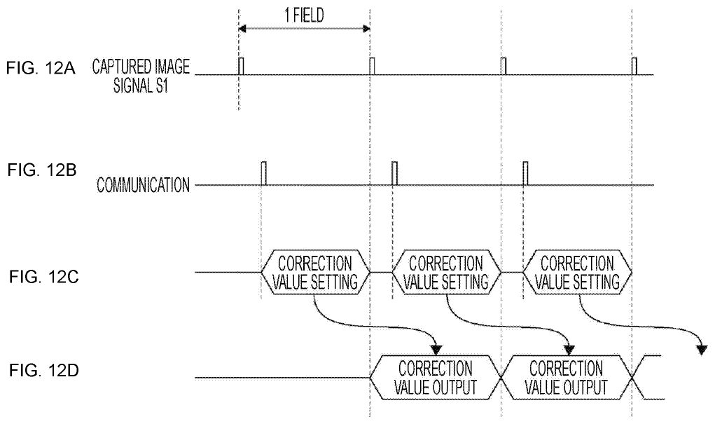

FIG. 12 shows an example of operation timings in shading correction to be performed in such process.

FIG. 12A shows the one-field periods (vertical synchronization timings) of the captured image signal S1.

As shown in FIG. 12B, for example, the camera control unit 30 communicates with the lens barrel 2 in synchronization with the one-field timings of the captured image signal S1.

FIG. 12C shows correction value setting processes to be performed by the camera control unit 30, and FIG. 12D shows processes to output correction values (the correction coefficients k00 to kMN). That is, exit pupil distances Z are acquired through communication processes performed at intervals of one field, and the correction value setting processes are performed in accordance with the exit pupil distances Z and transmittances TR.

The set correction values are supplied to the camera signal processing unit 13 during the period of the next field. As a result, the captured image signal S1 of the next field period is multiplied by the correction values set during the period of the one field, and shading correction is then performed.

It should be noted that this timing is merely an example. Various communication intervals are conceivable. For example, in a case where communication is performed at intervals of n fields, the correction coefficients k set after the communication may also be used during the period of the subsequent n fields of the captured image signal S1.

Alternatively, communication synchronized with the captured image signal S1 is not necessarily performed.

The camera control unit 30 may also communicate with the lens barrel 2 when the exit pupil distance Z is likely to change. For example, when the lens barrel 2 is attached, or when a zooming instruction is issued, the camera control unit 30 communicates with the lens barrel 2.

Meanwhile, a shading correction operation similar to the above is also performed as correction of shading caused by the lens system 21. The amount of shading caused by the lens system 21 has a correlation with the exit pupil distance Z and the aperture value IS of the diaphragm mechanism.

Therefore, the information acquisition unit 66 acquires information about the aperture value IS and the exit pupil distance Z by communicating with the lens barrel 2.

The correction value setting unit 65 performs a process of setting correction values, in accordance with the information about the exit pupil distance Z and the aperture value IS acquired by the information acquisition unit 66.

For example, the correction coefficient table corresponding to the combination of the exit pupil distance Z and the aperture value IS is identified from among the correction coefficient tables stored in the memory unit 31, and the correction coefficients for the respective pixels in the correction coefficient table are acquired. Alternatively, an interpolation process is performed, to generate correction coefficients for the respective pixels.

The correction value output unit 64 supplies the correction coefficients set by the correction value setting unit 65, such as the correction coefficients kL for the respective pixels in one field, to the camera signal processing unit 13, and then causes the coefficient multiplier 72 to perform a multiplication process.

As the shading caused by the lens system 21 is also corrected as described above, it is possible to obtain a captured image in which the influence of shading as well as the shading caused by the liquid crystal light control device 11 is eliminated or reduced. Thus, the quality of each captured image can be increased.

### 4. Summary and Modifications

In the above embodiment, the effects described below are achieved.

The imaging apparatus 1 according to the embodiment includes: the mount portion 80 on which the lens barrel 2 an interchangeable lens is mounted; the liquid crystal light control device 11 that performs light control on incident light entering via the lens system 21 of the lens barrel 2 when the lens barrel 2 is mounted on the mount portion 80; and the imaging device 12 that generates a captured image signal by photoelectrically converting the incident light entering via the liquid crystal light control device 11.

In a lens-interchangeable imaging apparatus, a light control device is normally disposed on the interchangeable lens side. However, in a case where a liquid crystal light control device is included in an interchangeable lens, light control devices need to be provided for all the interchangeable lenses, or light control devices need to be prepared for all the kinds of the interchangeable lenses, to achieve functions such as automatic light control.

In this embodiment, on the other hand, the liquid crystal light control device 11 is disposed in the main body of the imaging apparatus 1 to which an interchangeable lens is attached. In the lens-interchangeable imaging apparatus 1 having the above configuration, a light control function can be achieved through a combination with various lens systems 21.

Particularly, in this case, the mount portion 80, the liquid crystal light control device 11, and the imaging device 12 are arranged in this order from the object side in the optical axis direction of incident light. Thus, a layout suitable for light control operations is achieved.

Also, where the liquid crystal light control device 11 is disposed on the side of the lens barrel 2, the liquid crystal light control device 11 affects the external shape and the exterior of the lens barrel as an interchangeable lens, resulting in putting restrictions on design. For example, if specifications and functions for incorporating the liquid crystal light control device 11 are added to the lineup of conventional interchangeable lenses, the external shapes and the exteriors of the interchangeable lenses need to be greatly changed.

In this embodiment, exposure control similar to that in a case where a variable ND filter or ND is used can be advantageously performed or the like, without the above influence on the side of the lens barrel 2.

Further, where the liquid crystal light control device 11 is disposed in a lens, the use of the liquid crystal light control device 11 is restricted by the circuits on the side of the camera main body to which the lens is to be connected. Therefore, to use the liquid crystal light control device 11 for various purposes in a lens-interchangeable camera system, the liquid crystal light control device 11 should be disposed in the main body of the imaging apparatus 1.

The imaging apparatus 1 further includes a signal processing unit 13 that performs a first correction process (a process to be performed by the coefficient multiplier 71) on the captured image signal S1 output from the imaging device 12, to correct shading caused by the liquid crystal light control device 11.

As the first correction process is performed on the captured image signal so that the shading caused by disposing the liquid crystal light control device 11 does not appear in the captured image, it is possible to avoid degradation of the image quality of the captured image due to the liquid crystal light control device.

The signal processing unit 13 also performs a second correction process (a process to be performed by the coefficient multiplier 72) to correct shading caused by the lens system 21.

That is, in addition to the above described first correction process, the second correction process is performed to correct shading caused by the lens system 21.

As a result, shading in the captured image can be eliminated or reduced, and the quality of the captured image can be increased.

In accordance with an exit pupil distance Z and a transmittance TR of the liquid crystal light control device 11, the camera control unit 30 also sets correction values for the first correction process, which is the correction process for shading caused by the liquid crystal light control device 11.

A shading state appears depending on a relationship between the angle of a ray of incident light and the angle of liquid crystal molecules. The angle of the incident light is determined by the exit pupil distance, and the angle of the liquid crystal molecules depends on the transmittance.

Therefore, the shading caused by the liquid crystal light control device 11 changes with exit pupil distances Z and transmittances TR. In view of this, correction values are determined in accordance with exit pupil distances Z and transmittances TR. Thus, the correction process for the shading caused by the liquid crystal light control device 11 appropriately functions, and the image quality of each captured image can be increased.

In the liquid crystal light control device 11 that contains predetermined dye molecules (dichroic dye molecules) as well as guest-host liquid crystal molecules in the liquid crystal layers (45 and 48), the intensity of output light is determined by the direction in which the liquid crystal molecules are tilted and the angle of the ray of incident light.

That is, where imaging is performed via the liquid crystal light control device 11 having an orientation direction such as rubbing in the camera optical system, shading occurs in a direction depending on the orientation direction.

The angle of liquid crystal molecules changes, as a voltage is applied, and a variable transmittance is set. Therefore, it is necessary to correct the transmittance of the liquid crystal.

Meanwhile, the angle of incident light is determined by the lens optical system disposed on the front side of the liquid crystal light control device 11. In a lens optical system having a relatively long exit pupil distance Z, the change in the incident angle is small, and the shading correction amount is also small for operational reasons. On the other hand, in a lens optical system having a short exit pupil distance Z, such as a wide-angle lens, the change in the incident angle is large for a subtle zoom change in principle, and the amount of shading is also large.

That is, shading caused by the liquid crystal light control device 11 in the lens-interchangeable imaging apparatus 1 that copes with various exit pupil distances Z cannot be appropriately corrected in accordance only with the transmittance of the liquid crystal light control device 11.

Therefore, it is preferable to set correction values in accordance with exit pupil distances Z and transmittances TR as described above.

Thus, in a case where the liquid crystal light control device 11 is disposed on the side of the main body of the imaging apparatus 1 in the lens-interchangeable camera system, it is possible to avoid degradation of uniformity in images due to the shading phenomenon unique to the liquid crystal light control device 11 that are compatible with a plurality of interchangeable lenses (the lens barrel 2).

In the embodiment, the communication unit 34 that performs communication with the lens barrel 2 is further provided, and the camera control unit 30 acquires information about the exit pupil distance Z from the lens barrel 2 through the communication performed by the communication unit 34.

As the information about the exit pupil distance Z is acquired from an interchangeable lens through communication, information about the exit pupil distance corresponding to the attached lens can be acquired even after lenses are interchanged.

As a result, appropriate shading correction can be performed in accordance with the attached interchangeable lens, regardless of lens interchanges.

To perform shading correction in accordance with the transmittance TR and the exit pupil distance Z as described above, it is necessary to prepare correction value data based on the incident angle for each interchangeable lens. There are some interchangeable lenses with incident angles that vary with zoom positions. In a case where lens shading correction is performed in an interchangeable lens, a lens control circuit is disposed on the interchangeable lens side.

In view of these circumstances, acquiring the exit pupil distance Z from the attached lens barrel 2 through communication enables highly efficient and accurate correction.

The camera control unit 30 also causes the communication unit 34 to communicate with the lens barrel 2 at predetermined time intervals, and acquires information about the exit pupil distance Z.

As communication is performed at predetermined time intervals, exit pupil distance information can be successively obtained.

As a result, appropriate shading correction can be performed in accordance with changes in the exit pupil distance caused by movement of the zoom lens.

In the embodiment, the liquid crystal light control device 11 has a two-layer structure including the liquid crystal layers 45 and 48 as shown in FIG. 5. However, this structure is merely an example. A liquid crystal light control device having a single-layer structure formed with one liquid crystal layer may be used.

Further, the camera control unit 30 variably controls the transmittance TR of the liquid crystal light control device 11. That is, the light control drive circuit 32 s controlled by the light control signal SG1.

If the camera control unit 30 is designed to variably control the transmittance TR of the liquid crystal light control device 11, the camera control unit 30 can recognize the current transmittance of the liquid crystal light control device 11 from the controlled value of the transmittance, without acquiring information about the transmittance TR from outside. Thus, the process of detecting a transmittance for a correction value setting process is facilitated.

In the imaging apparatus 1, the terminal portion 85 for communication is also provided on the mount portion 80. When the lens barrel 2 is mounted on the mount portion 80, the terminal portion 85 is brought into contact with the communication terminal portion of the lens barrel 2. With this, a communication path is formed between the communication unit 34 and the attached lens barrel 2. As communication with the lens barrel 2 is performed in a contact state as described above, stable communication can be successively performed, and shading correction can also be appropriately performed.

Also, in the imaging apparatus 1, the liquid crystal light control device 11 can be retracted from the incident light path.

Further, while the liquid crystal light control device 11 is in a retracted state, the clear glass 82 is inserted into the incident light path.

As the liquid crystal light control device 11 is retracted, the transmittance can be maximized. Also, as the clear glass 82 is inserted into the incident light path when the liquid crystal light control device 11 is retracted from the incident light path, it is possible to achieve a state similar to the optical state in a case where the liquid crystal light control device 11 is in the incident light path. With this, changes in the optical characteristics depending on the presence or absence of the liquid crystal light control device 11 in the incident light path are reduced, and the image quality is stabilized, regardless of whether the liquid crystal light control device 11 is in a retracted state.

Further, the liquid crystal light control device 11 in a retracted state is located in a position that overlaps the mount ring 80a in the mount portion 80 when viewed from the optical axis direction of the incident light. As a result, it becomes possible to reduce the necessary space in the space R1 for retraction. Accordingly, the external shape of the housing of the imaging apparatus 1 can be prevented from becoming larger.

When the liquid crystal light control device 11 is inserted into the incident light path, the clear glass 82 is retracted from the incident light path, and is located in a position that overlaps the mount ring 80a when viewed from the optical axis direction of the incident light. As a result, it becomes possible to reduce the necessary space in the space R2 for retraction. Accordingly, the external shape of the housing of the imaging apparatus 1 can be prevented from becoming larger.

Furthermore, although the imaging apparatus 1 according to the embodiment has been described as an example of a lens-interchangeable camera system, the technology of the present disclosure can also be applied to a lens-integrated camera like the one shown in FIG. 1C.

That is, in a case where the exit pupil distance Z changes with the zoom lens position, it is desirable to set shading correction values in accordance with the changes.

Therefore, in a lens-integrated imaging apparatus, the exit pupil distance as the characteristics of the lens system is 50 mm or shorter, for example, the exit pupil distance of the lens changes in operation, and the liquid crystal light control device is used for the main body.

The reason why the exit pupil distance is 50 mm or shorter, for example, is that, in a lens optical system having a short exit pupil, the incident angle greatly changes with a subtle zoom change in principle, and the shading amount also increases.

In such a lens-integrated imaging apparatus, it is preferable to check the exit pupil distance of the lens system, and perform shading correction in accordance with information about the exit pupil distance and the correction values corresponding to the transmittance setting in the liquid crystal light control device 11.

It should be noted that the advantageous effects described in this specification are merely examples, and the advantageous effects of the present technology are not limited to them or may include other effects.

It should be noted that the present technology may also be embodied in the configurations described below.

(1) An imaging apparatus including:

a mount portion on which an interchangeable lens is mounted;

a liquid crystal light control device that performs light control on incident light entering via a lens system in the interchangeable lens when the interchangeable lens is mounted on the mount portion; and

an imaging device that generates a captured image signal by photoelectrically converting the incident light via the liquid crystal light control device.

(2) The imaging apparatus of (1), further including

a signal processing unit that performs a first correction process on the captured image signal output from the imaging device, to correct shading caused by the liquid crystal light control device.

(3) The imaging apparatus of (2), in which the signal processing unit further performs a second correction process on the captured image signal output from the imaging device, to correct shading caused by the lens system.

(4) The imaging apparatus of (2), further including

a control unit that sets a correction value for the first correction process, in accordance with an exit pupil distance and a transmittance of the liquid crystal light control device.

(5) The imaging apparatus of (4), further including a communication unit that performs communication with the interchangeable lens mounted on the mount portion,

in which the control unit acquires information about the exit pupil distance from the interchangeable lens through the communication performed by the communication unit.

(6) The imaging apparatus of (5), in which the control unit causes the communication unit to perform communication with the interchangeable lens at predetermined time intervals, to acquire the information about the exit pupil distance.

(7) The imaging apparatus of any of (4) to (6), in which the control unit variably controls the transmittance of the liquid crystal light control device.

(8) The imaging apparatus of (5) or (6), in which a communication terminal is provided on the mount portion, and the communication terminal is brought into contact with a communication terminal of the interchangeable lens when the interchangeable lens is mounted on the mount portion, to form a communication path between the communication unit and the interchangeable lens mounted on the mount portion.

(9) The imaging apparatus of any of (1) to (8), in which the liquid crystal light control device can be retracted from an incident light path.

(10) The imaging apparatus of (9), in which a clear glass is inserted into the incident light path while the liquid crystal light control device is in a retracted state.

(11) The imaging apparatus of (9), in which the liquid crystal light control device in a retracted state is located in a position overlapping a mount ring in the mount portion when viewed from the optical axis direction of the incident light.

(12) The imaging apparatus of (10), in which, when the liquid crystal light control device is inserted into the incident light path, the clear glass is retracted from the incident light path, and is located in a position overlapping a mount ring in the mount portion when viewed from the optical axis direction of the incident light.

(13) A shading correction method implemented in an imaging apparatus that includes:

a mount portion on which an interchangeable lens is mounted;

a liquid crystal light control device that performs light control on incident light entering via a lens system in the interchangeable lens when the interchangeable lens is mounted on the mount portion;

an imaging device that generates a captured image signal by photoelectrically converting the incident light via the liquid crystal light control device; and

a signal processing unit that performs a correction process on the captured image signal output from the imaging device, to correct shading caused by the liquid crystal light control device,

the shading correction method including

setting a correction value for the correction process, in accordance with information about an exit pupil distance and a transmittance of the liquid crystal light control device.

### REFERENCE SIGNS LIST

1 Imaging apparatus
2 Lens barrel
11 Liquid crystal light control device
12 Imaging device
13 Camera signal processing unit
14 Recording unit
15 Output unit
30 Camera control unit
31 Memory unit
32 Light control drive circuit
34 Communication unit
81 Cover glass
82 Clear glass
85 Terminal portion

1. An imaging apparatus comprising:
a liquid crystal light control device that performs light control on incident light entering via a lens system;
an imaging device that generates a captured image signal by photoelectrically converting the incident light via the liquid crystal light control device; and
a signal processing unit that performs a first correction process on the captured image signal output from the imaging device, to correct shading caused by the liquid crystal light control device.

2. The imaging apparatus according to claim 1, further comprising
a mount portion on which an interchangeable lens is mounted,
wherein the liquid crystal light control device performs light control on incident light entering via a lens system in the interchangeable lens, when the interchangeable lens is mounted on the mount portion, and
the mount portion, the liquid crystal light control device, and the imaging device are arranged in a corresponding order from a side of an object in an optical axis direction of the incident light.

3. The imaging apparatus according to claim 1, wherein the signal processing unit further performs a second correction process on the captured image signal output from the imaging device, to correct shading caused by the lens system.

4. The imaging apparatus according to claim 1, further comprising
a control unit that sets a correction value for the first correction process, in accordance with an exit pupil distance and a transmittance of the liquid crystal light control device.

5. The imaging apparatus according to claim 4, further comprising:
a mount portion on which an interchangeable lens is mounted; and
a communication unit that performs communication with the interchangeable lens mounted on the mount portion,
wherein the control unit acquires information about the exit pupil distance from the interchangeable lens through the communication performed by the communication unit.

6. The imaging apparatus according to claim 5, wherein the control unit causes the communication unit to perform communication with the interchangeable lens at predetermined time intervals, to acquire the information about the exit pupil distance.

7. The imaging apparatus according to claim 4, wherein the control unit variably controls the transmittance of the liquid crystal light control device.

8. The imaging apparatus according to claim 5, wherein a communication terminal is provided on the mount portion, and the communication terminal is brought into contact with a communication terminal of the interchangeable lens when the interchangeable lens is mounted on the mount portion, to form a communication path between the communication unit and the interchangeable lens mounted on the mount portion.

9. The imaging apparatus according to claim 1, wherein the liquid crystal light control device can be retracted from an incident light path.

10. The imaging apparatus according to claim 9, wherein a clear glass is inserted into the incident light path while the liquid crystal light control device is in a retracted state.

11. The imaging apparatus according to claim 9, further comprising
a mount portion on which an interchangeable lens is mounted,
wherein the liquid crystal light control device in a retracted state is located in a position overlapping a mount ring in the mount portion when viewed from an optical axis direction of the incident light.

12. The imaging apparatus according to claim 10, further comprising
a mount portion on which an interchangeable lens is mounted,
wherein, when the liquid crystal light control device is inserted into the incident light path, the clear glass is retracted from the incident light path, and is located in a position overlapping a mount ring in the mount portion when viewed from an optical axis direction of the incident light.

13. A shading correction method implemented in an imaging apparatus,
the imaging apparatus including:
a mount portion on which an interchangeable lens is mounted;
a liquid crystal light control device that performs light control on incident light entering via a lens system in the interchangeable lens when the interchangeable lens is mounted on the mount portion;
an imaging device that generates a captured image signal by photoelectrically converting the incident light via the liquid crystal light control device; and
a signal processing unit that performs a correction process on the captured image signal output from the imaging device, to correct shading caused by the liquid crystal light control device,
the shading correction method comprising
setting a correction value for the correction process, in accordance with information about an exit pupil distance and a transmittance of the liquid crystal light control device.
